(19) United States
(12) Patent Application Publication
(10) Pub. No.: US 2023/0268583 A1
(43) Pub. Date: Aug. 24, 2023

(54) BATTERY

(71) Applicant: SABIC Global Technologies B.V., Bergen op Zoom (NL)

(72) Inventor: Sreekanth Pannala, Sugar Land, TX (US)

(21) Appl. No.: 18/015,288

(22) PCT Filed: Jul. 9, 2021
(86) PCT No.: PCT/EP2021/069231

§ 371 Date: Jan. 9, 2023

(30) Foreign Application Priority Data
Jul. 10, 2020 (IN) 202041029448

(51) Int. Cl. H01M 10/654; H01M 50/209; H01M 4/70; H01M 50/507

(52) U.S. Cl. CPC H01M 10/654; H01M 50/209; H01M 4/70; H01M 50/507

(57) ABSTRACT

The present disclosure includes systems, devices, and methods of using a battery cell. The cell may include a container defining a cavity and a plurality of power units, a first conductive member, and/or a second conductive member disposed within the cavity. Each power unit includes a first electrode, a second electrode, and a separator disposed between the first and second electrodes. In some aspects, the first conductive member is coupled to the first electrodes of the plurality of power units and is disposed within the cavity between the first electrodes and at least one of one or more walls of the container to facilitate heat transfer and homogenization of current within the cell.

### TECHNICAL FIELD

The present disclosure relates generally to thermal management of one or more battery power units, and more specifically, but not by way of limitation, to rechargeable battery cells.

### BACKGROUND

Batteries are becoming increasingly used to power electronic and mechanical devices in a wide range of applications, such as mobile phones, tablets, personal computers, hybrid electric vehicles, fully electric vehicle and energy storage systems. Specifically, rechargeable batteries, such as Lithium-ion (Li-ion) batteries, have become popular due to several compelling features such as high power and energy densities, long cycle life, excellent storage capabilities, and memory-free recharge characteristics. Rechargeable batteries are designed to offer high power output and to be repeatedly charged and discharged for long-term use, as such, battery lifetime (e.g., total lifetime and lifetime per charge), battery safety, and battery size are imperative to battery design.

Some rechargeable batteries include a battery pack having several battery power units (e.g., cells or battery cells) connected in series and/or parallel to create a battery pack with higher capacity and power output for larger, more demanding applications, such as electric vehicles. However, the number of cells needed to output the desired power in high power applications may create several problems. In some instances, conventional high power battery packs can be overly cumbersome and can add excessive weight to the device and may even take up too much space to be implemented. Further, the higher the number of power units used in high powered battery packs increases the operational temperature of the battery packs. Rechargeable batteries typically operate at room temperature (e.g., between 20-40° C.), and at temperatures outside of this range the capacity decreases rapidly and the batteries become prone to serious thermal hazards (e.g., shorts from a dendrite, overcharge, or a mechanical crush/crash leading to a series of heat release events causing thermal runaway). Additionally, significant temperature variations can occur between individual power units in high power battery packs, resulting in an electrical imbalance.

### SUMMARY

The present disclosure is generally related to systems, devices, and methods of temperature control of a battery pack having one or more battery power units. For example, a system may include a plurality of power units arranged to prevent thermal runaway or excessive temperature gradients within the power units. Battery pack may include battery power units and a first conductive member disposed within a cavity defined by one or more walls of a container. Each of the power units include a first electrode, a second electrode, and a separator disposed between the first and second electrode. The first conductive member may include a portion of the first electrode, a first busbar or other conductive structure coupled to the first current collector, or a conductive coating on the container or enclosure of power units, or a combination thereof. The first conductive member is coupled to the first electrodes of the plurality of power units and is disposed within the cavity between the first electrodes and at least one of the one or more walls of the container. The first conductive member (e.g., the first busbar or first current collector) may distribute (or dissipate) heat away from the power units and toward the walls of the container to reduce the operational temperatures of the power units. Such positioning of the first conductive member may also enable external cooling components to easily transfer heat away from the first busbar for additional cooling of the cell. In some such implementations, the first conductive member is in contact with each first electrode of the plurality of power units to evenly distribute heat across every power unit. Additionally, or alternatively, the first conductive member may also enable external, heating components to easily heat up the battery for cold-start or reduce resistance for fast charging.

In some implementations of the present systems, devices, and methods, the cell includes a plurality of power units coupled together and disposed within the container, and each power unit includes: a first current collector; a second current collector; and a separator disposed between the first current collector and the second current collector. A first conductive member, such as a first busbar, is coupled to the plurality of power units such that the first conductive member is in contact with the first current collectors of the plurality of power units. In this way and others, the first conductive member and a first connector may operate in conjunction to efficiently remove heat from the power units via conduction to maintain substantially uniform temperatures across each power unit and minimize hotspots in the cell. Some implementations include a second conductive member coupled to the plurality of power units such that the second conductive member is in contact with the second current collectors of the plurality of power units to further reduce heat buildup in the cell. Additionally, in some implementations, the first current collector includes or is unitary with the first conductive member (e.g., first busbar).

In some such implementations, each power unit may include a first connector that includes a first portion and a second portion extending from the first portion. The second portion is in contact with the first conductive member. In at least some implementations, the second portion extends in a direction that is substantially perpendicular to the first portion to distribute heat along each plane of the cell. In some implementations of the present systems, devices, and methods, the first conductive member spans an area that is greater than or equal to 50% of a first wall of the container to increase heat distribution and to ensure contact with each current collector. In this way and others, the conductive member(s) may efficiently remove heat from the power units permitting the cell to have an increased power unit count while marinating desired operational temperatures for increased power and lifespan of the cell.

In some implementations of the present apparatuses, the one or more walls include a first wall and a second wall that opposes the first wall, each of the first and second walls defining a portion of a cavity. In some of the foregoing implementations, the first electrode includes a first active material and the first connector. The first active material may be coupled to a first portion of the first current collector. In some implementations, a second portion of first current collector extends in a direction that is substantially parallel to a width of the first conductive member. Additionally, or alternatively, the first conductive member is positioned between a first wall of the one or more walls and the second portion of first current collector. In some implementations, the first conductive member is in contact with the second portion of first current collector.

In some of the foregoing implementations, the second conductive member may be interposed between the second electrodes and the second wall. The second electrodes include a second current collector having a first portion and a second portion extending away from the first portion, and an active material coupled to the first portion of the second current collector. The first portion of the first current collector may be substantially parallel to the first portion of second current collector. Additionally, or alternatively, the second portion, of the first current collector is substantially parallel to the second portion of second current collector. In some implementations, the first conductive member spans an area that is greater than or equal to 25% of the first wall. Additionally, or alternatively, the second conductive member spans an area that is greater than or equal to 25% of the second wall.

In some such implementations, the cell may be arranged such that each power unit of the plurality of power units is stacked together so first portions of each power unit are substantially parallel to one another. In a cross-section of the container, taken perpendicularly to a length of the container, the second portion of the first connector extends in a direction that is substantially perpendicular to the first portion of the first connector. Additionally, or alternatively, the second current collector includes a third portion and a fourth portion extending from the third portion, the fourth portion in contact with the second conductive member. In some implementations, the second conductive member is interposed between the each fourth portion of the second current collectors and the second side of container. Additionally, or alternatively, the first current collectors and the first conductive member may each include a first material and the second current collectors and the second conductive member may each include a second material.

As used herein, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, and 10 percent.

The term “about” as used herein can allow for a degree of variability in a value or range, for example, within 10%, within 5%, or within 1% of a stated value or of a stated limit of a range and includes the exact stated value or range. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed implementation, the term “substantially” may be substituted with “within [a percentage] of” what is specified, where the percentage includes 0.1, 1, or 5 percent; and the term “approximately” may be substituted with “within 10 percent of” what is specified. The statement “substantially X to Y” has the same meaning as “substantially X to substantially Y,” unless indicated otherwise. Likewise, the statement “substantially X, Y, or substantially Z” has the same meaning as “substantially X, substantially Y, or substantially Z,” unless indicated otherwise. The phrase “and/or” means and or or. To illustrate, A, B, and/or C includes: A alone, B alone, C alone, a combination of A and B, a combination of A and C, a combination of B and C, or a combination of A, B, and C. In other words, “and/or” operates as an inclusive or. Additionally, the phrase “A, B, C, or a combination thereof” or “A, B, C, or any combination thereof” includes: A alone, B alone, C alone, a combination of A and B, a combination of A and C, a combination of B and C, or a combination of A, B, and C.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus that “comprises,” “has,” or “includes” one or more elements possesses those one or more elements, but is not limited to possessing only those one or more elements. Likewise, a method that “comprises,” “has,” or “includes” one or more steps possesses those one or more steps, but is not limited to possessing only those one or more steps.

Any implementation of any of the systems, methods, and article of manufacture can consist of or consist essentially of—rather than comprise/have/include—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb. Additionally, the term “wherein” may be used interchangeably with “where”. Further, a device or system that is configured in a certain way is configured in at least that way, but it can also be configured in other ways than those specifically described. The feature or features of one implementation may be applied to other implementations, even though not described or illustrated, unless expressly prohibited by this disclosure or the nature of the implementations.

Some details associated with the implementations are described above, and others are described below. Other implementations, advantages, and features of the present disclosure will become apparent after review of the entire application, including the following sections: Brief Description of the Drawings, Detailed Description, and the Claims.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers.

FIG. 1A is a side view of an example of a thermal management system including a battery cell.

FIG. 1B is a top view of the cell of FIG. 1A

FIG. 2A is a perspective view of an, example of a battery cell of the present thermal management system.

FIG. 2B is a top cross-sectional view of the cell of FIG. 2A.

FIG. 3 is a perspective view of an example of a battery pack.

FIG. 4 is a flowchart of an example of a method of operating a battery cell of the present thermal management system.

FIG. 5 is an anode and cathode of a regular cell (comparative).

FIG. 6 is a regular cell assembly (comparative).

FIG. 7 is an anode and cathode of inventive cell(inventive).

FIG. 8 is an inventive cell assembly (inventive).

FIG. 9 is comparative vs. inventive cell assembly (˜5 AH cells).

FIG. 10 details thermocouple placements on comparative and inventive cell

FIG. 11 shows the cycler setup

FIG. 12 shows temperature vs. current profiles with time for the inventive cell. The cell is charged at 1 C and discharged at 5 C with no active cooling between two fiberglass plates. The temperatures can reach between 45 and 50° C. at the end of the discharge as the internal thermal tab reflects the highest temperature in the cell.

FIG. 13 shows temperature vs. current profiles with time for the comparative cell. The cell is charged at 1 C and discharged at 5 C with no active cooling between two fiberglass plates. The temperatures can reach to −40° C. at the end of the discharge as the surface temperature is not reflective of the highest temperature in the cell.

FIG. 14 shows cycling of the inventive cell with no active cooling at 1 C charge and 2 C discharge

FIG. 15 shows cycling of the inventive cell with no active cooling at 1 C charge and 1 C discharge

### DETAILED DESCRIPTION

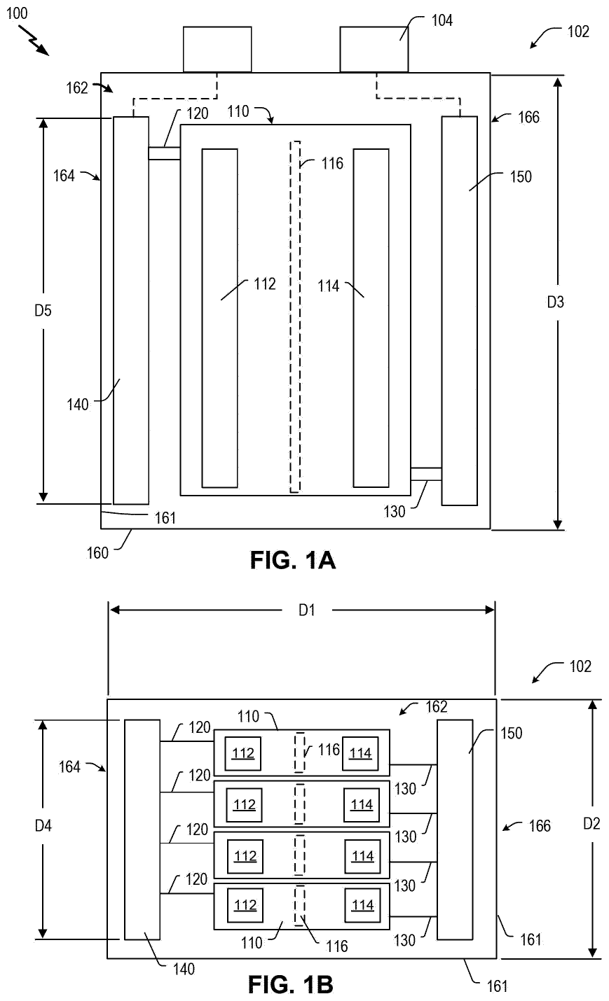

Referring to FIGS. 1A-1B, illustrative views of a thermal management system 100 are shown. For example, FIG. 1A shows a side view of an illustrative example of thermal management system 100 including a battery cell 102 (e.g., cell) and FIG. 1B shows a top cross-sectional view of the cell. System 100 may be configured to regulate operational temperatures of one or more power generation units (e.g., 110) of cell 102.

Cell 102 may include a plurality of power generation units (“power units”) 110 and one or more conductive members, such as a first busbar 140 and a second busbar 150, configured to transfer heat from the power units. Although referred to herein as power units 110, container 160 may also be referred to as a cell sandwich, a jelly roll, or the like. In some implementations, each power unit (e.g., 110) and/or conductive members may be disposed within container 160 to allow for safe handling of cell 102. Cell 102 may include one more electrical connections 104 (e.g., terminals) configured to be connected (e.g., via wiring or other connections) to one or more electronic devices (not shown) to provide power to the electronic devices. As shown, electrical connections 104 include a pair of electrode terminals configured to provide electrical current to a device when the device is coupled to the terminals. The depicted electrical connections 104 are shown at the top of cell 102, but the electrical connections may be located anywhere along the cell (e.g., at the top, bottom, sides or combination thereof). In some implementations, cell 102 is a rechargeable, or secondary, battery that can be discharged and recharged multiple times. In an illustrative, non-limiting example, cell 102 may be a lead-acid battery, nickel-cadmium (NiCd) battery, nickel-metal hydride (NiMH) battery, lithium-ion (Li-ion) battery, lithium-ion polymer battery, and/or the like.

As shown in FIGS. 1A and 1B, each power unit 110 includes a first connector 120 coupled to first active material 112 (e.g., first electrode), a second connector 130 coupled to second active material 114 (e.g., second electrode), and a separator 116 disposed between the first and second active materials. Separator 116 may be configured to prevent damage to the power units during charging or discharging operations. In some implementations, each power unit 110 may be aligned (e.g., in a horizontal plane, as shown in FIG. 1B) with one other power unit such that the power units form a stack. For example, each power unit 110 may be prismatic (e.g., include a rectangular cross-section) and disposed adjacent to one other power unit to enable multiple power units to be positioned within a small space (e.g., 162). As shown in FIG. 1B, cell 102 includes four power units 110 disposed in the stack; however, in other implementations, cell 102 may include less than four power units (e.g., 1, 2 or 3 power units) or more than four power units (e.g., greater than, equal to any one of, or between any two of: 5, 6, 8, 10, 12, 18, 24, 30 or more power units).

The first electrode (e.g., first active material 112 and first connector 120) and the second electrode (e.g., second active material 114 and second connector 130) may interact to cause an electrical and/or chemical reaction to generate power. As shown herein, the first electrode corresponds to a positive terminal and the second electrode corresponds to a negative terminal; however, in other implementations, the first electrode may correspond to the negative terminal and the second electrode corresponds to the positive terminal. In rechargeable power units, the first electrode may alternate between the cathode and the anode based on the state of cell 102. For example, the positive active material (e.g., 112) is the cathode in a discharge state and the anode in a charge state. First and second active materials 112, 114 may include any suitable material. In an illustrative, non-limiting example, first active material 112 may include a transition metal oxide (e.g., lithium cobalt oxide, lithium iron phosphate, lithium manganese oxide, and/or the like) and second active material 114 may include a carbon or silicon material or Li-metal (e.g., graphite, hard carbon, silicon carbon composite, Li-metal or alloys, and/or the like). Although described herein as separate components, first connector 120 and active material 112 and/or second connector 130 and active material 114 may be a single unitary component (e.g., fiber reinforced composite having an active material and conductive fibers, substrate with an active coating, or the like).

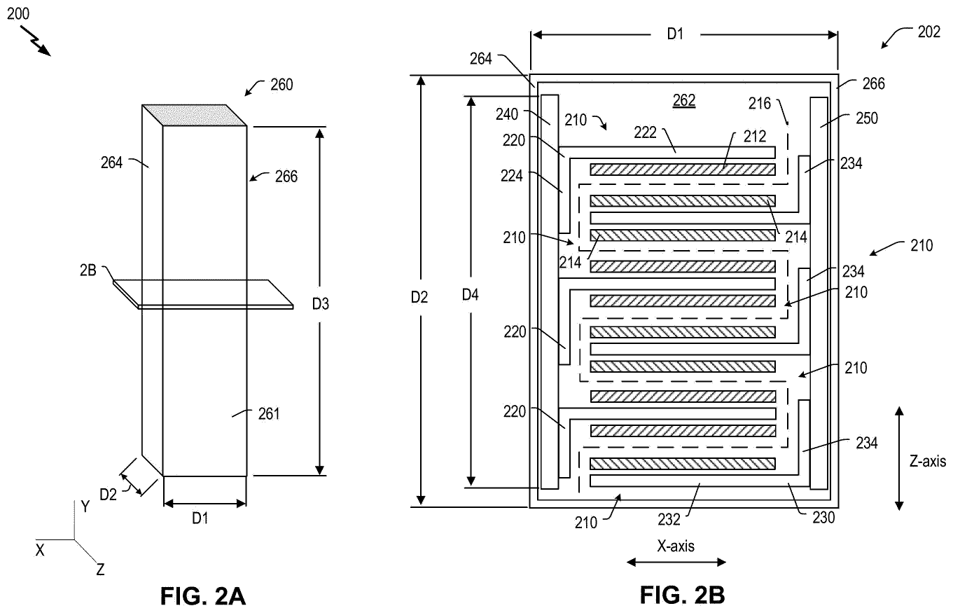

Separator 116 is positioned in between the first and second electrodes to prevent certain particles (e.g., electrons, ions, or the like) from travelling through the separator, between the first and second electrodes. In some implementations, separator 116 includes an electrolyte. For example, separator 116 may include a lithium salt in, an organic solvent, a water-based electrolyte, a mixture of organic carbonates (e.g., ethylene carbonate or diethyl carbonate), aqueous electrolytes, composite electrolytes, solid ceramic electrolytes, polymeric membranes, solid polymer electrolytes, and/or the like. In some implementations, separator 116 may include a single body that is disposed between the first and second electrodes of each power unit (as shown in FIG. 2B), while in other implementations, separator 116 may include several discrete separators (as shown in FIG. 1B) positioned between the first and second electrodes of the power units.

Connectors (e.g., 120, 130) are configured to transport electrical current and heat from active materials 112, 114 to one or more other components of cell 102. For example, a first connector 120 (e.g., first current collector) may be coupled to first active material 112 of one power unit 110 and a second connector 130 (e.g., second current collector) may be coupled to second active material 114 of the one power unit to distribute power produced from the power unit. In some implementations, each power unit 110 includes a first connector 120 and a second connector 130 coupled to the power unit to combine the output of the plurality of power units (e.g., 110) at a single source (e.g., one of the terminals) to achieve a higher energy output. The power units (e.g., 110) can be coupled to conductive members to distribute heat during operation. To illustrate, first connectors 120 may couple each first active material 112 to first busbar 140 and second connectors 130 may couple each second active material 114 to second busbar 150 to provide a low resistance path for electrical current between power units (e.g., 110) and to decrease operational temperatures of cell 102 by removing heat through the first and second busbars. As shown in FIG. 1B, first connector 120 extends from first active material 112 to first busbar 140 to connect the first active material to the first busbar, and second connector 130 extends from second active material 114 to a second busbar 150 to connect the second active material to the second busbar. In other implementations, first connector 120 or second connector 130 may be coupled to one or more other components of cell 102 (e.g., at electrical connections 104). Although, the conductive member is primarily described as first busbar 140 and/or second busbar 150, other suitable conductive members may be used (e.g., a mesh, a wire, a plate, a fin, a coil, a rigid structure, coating or inner surface 161, such as a conductive coating or surface, of container 160 or cell 102, and/or the like). In other implementations, cell 102 may not include first and second busbars 150, 152 and the first conductive member, container 160, such as a coating or inner conductive surface of the container 160, and/or the cell 102 may be configured to and distribute heat, current, or both.

Conductive members may be arranged within cell to distribute heat and/or electrical current. For example, first busbar 140 and second busbar 150 are positioned adjacent to the plurality of power units 110. As shown in FIG. 1B, each busbar (e.g., 140, 150) is coupled to one or more of the plurality of power units (e.g., 110) to allow electric current to flow from the power units to the busbar. For example, first busbar 140 may be coupled to or in contact with first connector 120, which is coupled to or in contact with a portion (up to and including all) of power units 110 of the plurality of power units. Such configuration of first busbar 140 and first connector 120 enables the first busbar to remove heat and transport current from the power units. Additionally, or alternatively, second busbar 150 may be substantially parallel to first busbar 140 and coupled to one or more second connectors 130. Such configuration of the second busbar 150 and second connectors 130 may allow for more efficient removal of heat from the power units. As such, busbars (e.g., 140, 150) may include a suitable highly thermally conductive material such, as aluminum, gold, copper, silver, tungsten, zinc, carbon (e.g., graphite, nanotubes), carbon composites, alloys or hybrids thereof, and/or the like. In some implementations, a connector (e.g., 120) may include the same material as a busbar (e.g., 140) to ensure electrochemical compatibility. For example, first busbar 140 and first connectors 120 may include aluminum or an aluminum alloy and second busbar 150 and second connectors 130 may include copper or a copper alloy. In some implementations, first busbar 140 and first connector 120 are a single, unitary component, second busbar 150 and second connector 130 are a single, unitary component, or a combination thereof.

In some implementations, first busbar 140 may be positioned substantially perpendicular to first connector 120 and/or power unit (e.g., 110). First busbar 140 may include a body that spans at least a portion (e.g., at least 25%) of the stack of power units (e.g., 110) to provide increased thermal conductivity along a horizontal plane in cell 102. For example, first busbar 140 may span at least 25% of a thickness (e.g., D2) of cell 102. Additionally, or alternatively, first busbar 140 may span at least 25% of a length (e.g., D3) of cell 102. First busbar 140 may include a unitary body or two or more discrete segments that are coupled together and collectively span the portion of the stack. In this way and others, first busbar 140 may enable temperature regulation of cell 102 by causing an efficient removal of heat from hot spots, thereby keeping the power units of cell 102 at near uniform temperature. Such thermal regulation may enable cell 102 to include thick, high-capacity power units without (or with reduced) risk of temperature-related events. Second busbar 150 may be positioned similarly to first busbar 140. For example, second busbar 150 may be substantially parallel to first busbar 140 to remove heat along the same plane as first busbar 140. Although cell 102 is described as including two busbars (e.g., 140, 150); in other implementations, cell 102 may include a single conductive member or more than two conductive members or extended to contact with multiple walls without shorting.

Container 160 defines a cavity 162 and includes a first side 164 (e.g., first wall) and a second side 166 (e.g., second wall). First side 164 may be opposite the second side 166 such that the first and second sides cooperate to define at least a portion of cavity 162. As shown in FIG. 1B, container 160 has a width D1 measured between first side 164 and second side 166 along a straight line. Container 160 also has a thickness D2 that is orthogonal to width D1 and is measured between opposing sides of container 160 along a straight line. Container 160 has a length D3 that is measured between a top and bottom the container along a straight line. In the depicted implementations, width D1 and thickness D2 are measured in a horizontal plane and length D3 is measured in a vertical plane. Container 160 may include a rigid, semi-rigid, or flexible material and may be shaped in any suitable manner (e.g., cylindrical, prismatic, or the like) based on the desired application of cell 102. In the implementation shown in FIGS. 1A and 1B, container 160 corresponds to a rectangular prism, which may enable cell 102 to be utilized in applications where a small, high-powered cell is required.

Power units 110, conductive members (e.g., 140, 150), and other components of cell 102 may be disposed within cavity 162. In this way, container 160 may provide an insulative protective casing around power units 110 and conductive members (e.g., 140, 150) to prevent electrical accidents or damage that may arise from handling cell 102. As shown in FIGS. 1A and 1B, power units 110 disposed within cavity 162 may be stacked along an axis that is parallel to thickness D2 of container 160. Conductive members (e.g., 140, 150) may be disposed between the stack of power units (e.g., 110) and the sides (e.g., 164, 166) of container 160. For example, first busbar 140 may be interposed between first side 164 and the stack of power units 110. Additionally, or alternatively, second busbar 150 may be interposed between second side 166 and the stack of power units 110.

Each conductive member may be completely disposed within container 160. In some implementations, first busbar 140 may be coupled to, or disposed adjacent to, first side 164. In some such implementations, first busbar 140 spans at least 25% of thickness D2 of container 160. For example, a width D4 of first busbar 140 may be greater than, equal to, or between any two of the following: 25, 30, 35, 40, 45, 50, 55, 65, 70, 75, 80, 85, 90, 95, 98, or 100 percent of thickness D2 at first side 164. Additionally, or alternatively, a length D5 of first busbar 140 spans at least 25% of length D3 of container 160, the length D5 being measured perpendicular to width D4 of the first busbar. For example, length D5 of first busbar 140 may be greater than, equal to, or between any two of the following: 25, 30, 35, 40, 45, 50, 55, 65, 70, 75, 80, 85, 90, 95, 98, or 100 percent of length D3 of container 160. In some implementations, first busbar 140 spans at least a majority of each of thickness D2 and length D3 of container 160 at first side 164. Second busbar 150 may be coupled to, or disposed adjacent to, second side 166 and span at least 25% (e.g., between 25% and 100%) of thickness D2 and/or length D3 of container 160 at the second side 166. While not depicted herein, first busbar 140 and/or second busbar 150 may include a section that extends along a third side and/or a fourth side of container 160. For example, first busbar 140 may include a third section that extends along a third side (e.g., between 10 and 90% of width D1) of container 160 and second busbar 150 may include fourth section that extends along a fourth side (e.g., between 10 and 90% of width D1) of the container. Alternatively, cell 102 may include a third and/or a fourth busbar disposed along a third side and a fourth side, respectively, of container 160.

In an illustrative implementation, cell 102 includes a container 160 having one or more walls (e.g., 164, 166) that define a cavity 162, a plurality of power units 110 disposed within the cavity and a first busbar 140 coupled to the plurality of power units. Each power unit includes a first electrode (e.g., 112, 120), a second electrode (e.g., 114, 130), and a separator 116 disposed between the first and second electrode. In some such implementations, the first busbar 140 is coupled to the first electrodes (e.g., 112, 120) and disposed within cavity 162 between the first electrodes and at least one of the one or more walls (e.g., 164). In yet another illustrative implementation, cell 102 includes a container 160 having a first side 164 and a second side 166 and a plurality of power units 110 coupled together and disposed within the container. The first side 164 of container 160 opposes second side 166, where the first and second sides each define at least a portion of cavity 162. Each power unit includes a first connector 120 (e.g., first current collector), a second connector 130 (e.g., second current collector), and a separator 116 disposed between the first current collector and the second current collector. In such an implementation, cell 102 includes a first busbar 140 coupled to the plurality of power units 110 such that the first busbar is in contact with first current collector (e.g., 120) of the plurality of power units and a second busbar 150 coupled to, the plurality of power units such that the second busbar is in contact with second current collector (e.g., 130) of the plurality of power units.

In some implementations, the plurality of power units 110, first busbar 140, and second busbar 150 are disposed within cavity 162. For example, first busbar 140 is interposed between first current collector (e.g., 120) and first side 164 of container 160. In some implementations, second busbar 150 is interposed between second current collector (e.g., 130) and second side 166 of container 160. In some implementations, first busbar 140 is in contact with each first electrode (e.g., 112, 120) of the plurality of power units 110. At least one of the first electrodes (e.g., 112, 120) includes a first current collector (e.g., 120) and an active material (e.g., 112). In some implementations, second electrodes (e.g., 114, 130) may include a second current collector (e.g., 130) coupled to second busbar 150. First current collector (e.g., 120) and first busbar 140 may each include a first material and second current collector (e.g., 130) and second busbar 150 may each include a second material. The first and second material may be the same or a different material. In some implementations, first busbar 140 spans an area that is greater than or equal to 25% of first wall (e.g., 164). Additionally, or alternatively, second busbar 150 spans an area that is greater than or equal to 25% of the second wall (e.g., 166).

In the foregoing implementations, first conductive member 140 may operate to efficiently remove heat from power units 110 and maintain substantially uniform temperatures across each power unit. For example, first busbar 140 may be coupled to first electrode (e.g., first active material and first connector) to remove heat away from each power unit 110 along a first plane that is parallel to the length D3 of container 160 and along a second plane that is parallel to the thickness D2 of the container. In this way and others, heat can be distributed from the power units to reduce operational temperatures of cell 102. Additionally, first busbar 140 may be positioned adjacent to first side 164 (e.g., first wall) to distribute heat toward the exterior of container 160. Such implementations may enable more efficient heat transfer from power units 110 due to the surface area of first busbar 140, easier access for external cooling components to the heat sink (e.g., first busbar), and other manners described herein.

Referring to FIGS. 2A-2B, examples of a cell 202 of an energy storage system 200 are shown. FIG. 2A shows a perspective view of cell 202 and FIG. 2B shows a cross-sectional view of the cell taken along plane 2B. Cell 202 may include or correspond to cell 102. For example, cell 202 includes a plurality of power units 210, a first busbar 240, and a second busbar 250 disposed within a container 260. The power units 210, first busbar 240, second busbar 250, and container 260 may include or correspond to power units 110, first busbar 140, second busbar 150, and container 160, respectively. Although described as including busbars 140, 150, in other implementations, cell 202 may not include busbars 140, 150. In implementations that do not include first and second busbars 140, 150, functional aspects of the first and second busbars 140, 150 may be realized by a conductive member, cell 220, container 160, such as the cell enclosure, and/or the like. To illustrate, the container 260, such as a coating or inner conductive surface of the container 160, may be configured to and distribute heat, current, or both.

As shown in FIG. 2A, container 260 includes one or more walls 261, a first side 264, and a second side 266 that is opposite to the first side. Walls 261 cooperate to define a cavity 262 in which components of cell 202 may be stored. In some implementations, first side 264 and second side 266 correspond to a first wall and second wall, respectively, of the one or more walls 261. In the depicted implementations, container 260 is prismatic (e.g., cuboid) and includes four walls (e.g., 261), yet, in other implementation, container 260 may be sized and shaped based on an application of cell 202. For example, a cross-section of container 260 may be rectangular (as shown in the implementation of FIG. 2B), triangular, hexagonal, pentagon, octagonal, or otherwise polygonal (whether having sharp and/or rounded corners), circular, elliptical, or otherwise rounded, or can have an irregular shape. Such implementations may allow cells (e.g., 202) to be densely packed (e.g., honeycomb, rectangular grid, or the like) and can distribute energy from an impact. For example, container 260, cells 202, or both may be highly compressible to buffer crash energy without going into runway as the energy gets distributed (rather than focused) by the cells.

By way of illustration, cell 202 may be described with reference to a right handed coordinate system, as shown in FIG. 2A, in which the x-axis corresponds to a left-right direction of the page, the y-axis corresponds to an up-down direction on the page, and the z-axis corresponds to an axis that travels orthogonally into the page. Container 260 has a width D1, a thickness D2, and a length D3, each of which may be measured along a straight line from opposing sides (e.g., walls) of container 260. As shown in FIG. 2A, width D1 is measured along the x-axis, thickness D2 is measured along the z-axis, and length D3 is measured along the y-axis. In the depicted implementation, thickness D2 may be greater than (e.g., 10% greater than) width D1, however, in other implementations, width D1 may be substantially equal to thickness D2 (e.g., cuboid), and, in yet other implementations, width D1 may be greater than thickness D2.

FIG. 2B shows a top sectional view of cell 202 taken about plane 2B in which the right handed coordinate system is rotated such that the x-axis corresponds to a left-right direction of the page and the z-axis corresponds to an up-down direction on the page. As shown, the Y-axis is not illustrated as it extends into and out of the page. Each power unit (e.g., 210) includes a first active material 212, a second active material 214, a separator 216, a first connector 220 (e.g., first current collector), and a second connector 230 (e.g., second current collector). First active material 212, second active material 214, and at least a portion of separator 216 are disposed between first connector 220 and second connector 230 of each power unit, the separator interposed between the first and second active materials 212, 214 to selectively permit particles travelling between the first and second active materials. First active material 212 is coupled to first connector 220 and a second active material 214 is coupled to the second connector 230 to create an electrical current that flows through cell 202 from one connector to the other. To illustrate, first active material 212 and second active material 214 may include materials that allow electrons to flow between the materials (e.g., transition metal oxide and carbon, as a non-limiting example). In some implementations, power units 210 may share components to decrease the volume of the power unit and allow cell 202 to be more compact. For example, a single first connector (e.g., 220) may be utilized as the first connector for two adjacent power units. In such implementations, the first connector (e.g., 220) is interposed between two layers of first active material (e.g., 212). Additionally, or alternatively, separator 216 may include a unitary body that that extends through each power unit 210 such that a portion of the separator is disposed between first active material 212 and second active material 214 of each power unit.

First connector 220 may include a body 222 (e.g., first portion) and a tab 224 (e.g., second portion). Body 222 is coupled to (e.g., in contact with) first active material 212 to collect an electrical charge as power unit 210 charges and discharges. To illustrate, body 222 may extend in a direction parallel to first active material 212 and, in some implementations, the body may span (or cover) approximately an entirety of first active material 212 (e.g., a surface area of the body is greater than a surface area of the first active material). As shown, at least a portion of body 222 extends past one end of active material (e.g., 212, 214). In this way and others, first connectors 220 may transfer heat away from power unit 210 to maintain normal operational temperatures during use of cell 202.

Tab 224 extends away from body 222. To illustrate, tab 224 may be angularly disposed relative to (e.g., perpendicular to) body 222 to direct current collected at body 222 to one or more other components of cell 202. For example, tab 224 of each first connector 220 may be in contact with conductive member (e.g., first busbar 240) to deliver electrical current generated from each power unit 210 to the first conductive member. In this manner, conductive member may distribute (or dissipate) heat from tab 224 via conduction. For example, connecting tabs 224 to first busbar 240 enables heat generated by power units 210 to be distributed by conduction from first connector 220 to the first busbar by increasing the interfacial contact area between tab 224 and first busbar 240. Such positioning and coupling of tab 224 and first busbar 240 may enable heat to be more readily transferred along the X-axis (along body 222) and the Z-axis (along tab 224 and first busbar 240) as compared to traditional batteries. In this manner and others, heat produced at each power unit 210 may be more uniformly distributed and can minimize hot spots that can occur within the cell. In some implementations, tab 224 may extend in a direction parallel to first busbar 240 (e.g., parallel to a width D4 of first busbar 240) to achieve a larger contact surface with the first busbar. In an illustrative, non-limiting example, tabs 224 may collectively span a distance of first busbar 240 that is greater than or equal to 25% (e.g., approximately 40, 50, 60, 70, or 75%) of width D4 of the first busbar. As a non-limiting example, each tab (e.g., 224, 234) may extend the thickness of one power unit 210 such that the tab extends approximately an entirety of the distance from a body (e.g., 222, 232) of one connector (e.g., 220, 230) to a body (e.g., 222, 232) of an adjacent connector (e.g., 220, 230). In addition, the internal thermal tabs can distribute heat to the peripheral (sides and bottom) with highly conductive materials to keep the cell nearly uniform with minimal thermal gradients—they also have the advantage of homogenizing electrical potential and ensure uniform utilization of all parts of the cell. Although described as including busbars 240, 250, in other implementations, busbars 240, 250 may be omitted from cell 202. Additionally or alternatively, cell 202 may include one or more conductive members, such as a mesh, a wire, a plate, a fin, a coil, a rigid structure, coating or inner conductive layer of container 260 or cell 202, and/or the like.

Second connector 230 may include one or more features similar to first connector 220. For example, second connector 230 includes a body 232 (e.g., first portion) and a tab 234 (e.g., second portion) that extends away from body 232. As shown in FIG. 2B, body 232 is in contact with second active material 214 and tab 234 is in contact with second busbar 250 to distribute current generated by power unit 210 to the second busbar. In some implementations, body 232 and tab 234 may be substantially parallel to active material 214 and second busbar 250, respectively. In an illustrative, non-limiting example, tabs 234 may collectively span a distance of second busbar 250 that is greater than or equal to 25% (e.g., approximately, 40, 50, 60, 70, or 75%) of a width (e.g., D4) of the second busbar. Additionally, or alternatively, body 232 of second connector 230 may be substantially parallel to body 222 of first connector 220. Likewise, tab 234 of second connector 230 may be substantially parallel to tab 224 of first connector 220. In this way and others, second connectors 230 may transfer heat away from power unit 210 to second busbar 250 via conduction to increase heat transfer in the X-axis (along body 232) and the Z-axis (along tab 234 and second busbar 250) to maintain normal operational temperatures during use of cell 202. Although described as and referred to as tabs 224, 234, in other implementation, tabs 224, 234 may include or correspond to a conductive member. In other implementations, tabs 224, 234 may be omitted.

First connector 220 (e.g., body 222 and tab 224) and/or second connector 230 (e.g., body 232 and tab 234) may include a thermally conductive material, such as aluminum, gold copper, silver, tungsten, zinc, carbon (e.g., graphite, nanotubes), carbon composites, alloys or hybrids thereof, and/or the like, to conduct electrical current and transfer heat away from power units 210. As shown in FIG. 2B, first connector 220 and second connector 230 may be unitary members. In some other implementations, first connector 220, second connector 230, or both, may include one or more discrete components coupled together. Although connectors 220, 230 are shown as being L-shaped, in other implementations first connector 220 and/or second connector 220, 230 may have approximately L-shaped or another shape. Although the components herein are described as distributing heat to cool the battery, it should be known the opposite is equally applicable to heat up the battery for best performance (e.g., to easily heat up the battery for cold-start, reduce resistance for fast charging, or the like).

Conductive members (e.g, first busbar 240 and second busbar 250) may be disposed on opposing sides of container 260. As shown, first busbar 240 is positioned adjacent to first side 264. For example, first busbar 240 may be in contact with first side 264 or, in other implementations, one or more gaps may be formed between the first busbar and first side 264. Additionally, or alternatively, second busbar 250 is positioned adjacent to second side 266. For example, second busbar 250 may be in contact with second side 266 or, in other implementations, one or more gaps may be formed between the second busbar and the second side 266. In some implementations, first busbar 240 may be positioned parallel to second busbar 250.

First busbar 240 has a width D4 that is measured from opposing sides of the first busbar along a straight line. In some implementations, first busbar 240 extends in a direction that is substantially parallel to first side 264. To illustrate, width D4 of first busbar 240 may be aligned parallel to a length of first side 264. As shown in FIG. 2B, a width of first side 264 corresponds to thickness D2 of container 260. In some implementations, a width D4 of first busbar 240 spans at least 25% of first side 264. For example, width D4 of first busbar 240 may be greater than, equal to, or between any two of the following: 25, 30, 35, 40, 45, 50, 55, 65, 70, 75, 80, 85, 90, 95, 98, or 100 percent of the width of first side 264 of container 260 (e.g., thickness D2). Additionally, or alternatively, a length (e.g., D5) of first busbar 240 may be greater than, equal to, or between any two of the following: 25, 30, 35, 40, 45, 50, 55, 65, 70, 75, 80, 85, 90, 95, 98, or percent of the length (e.g., D3) of first side 264 of container 260. In this way and others, first busbar 240 may increase heat transfer of cell 202 along the Y-axis and the Z-axis.

First busbar 240 includes a thermally conductive material. For example, first busbar 240 may include aluminum, gold, copper, silver, tungsten, zinc, alloys, structured carbon (fiber, nanotubes, graphene, etc.), fiber-reinforced composite, combinations thereof, and/or the like. In some implementations, first busbar 240 and first connector 220 include the same material (e.g., copper) to ensure electrochemical compatibility between the two components. For brevity, a discussion of second busbar 250 is omitted; however, it is noted that second busbar 250 and second connectors 230 may function similarly to, and include one or more structural similarities as, first busbar 240 and first connectors 220.

In the foregoing implementations, first busbar 240 and first connector 220 may operate in conjunction to efficiently remove heat from power units 210 and maintain uniform temperatures across each power unit. For example, first connector 220 may remove heat away from power units 210 along body 222 (in the X-axis) and tab 224 (in the Z-axis) and first busbar 240 may further remove heat (in the Z-axis). Additionally, each of first connector 220 and first busbar 240 span a portion of length D3 of container 260 to distribute heat along the Y-axis. In this way and others, first busbar 240 and/or first connector 220 may distribute heat along each plane of cell 202 to decrease operational temperatures. As a result of this thermal regulation, cell 202 may include more power units (e.g., 210) while still maintaining operational temperatures of the cell.

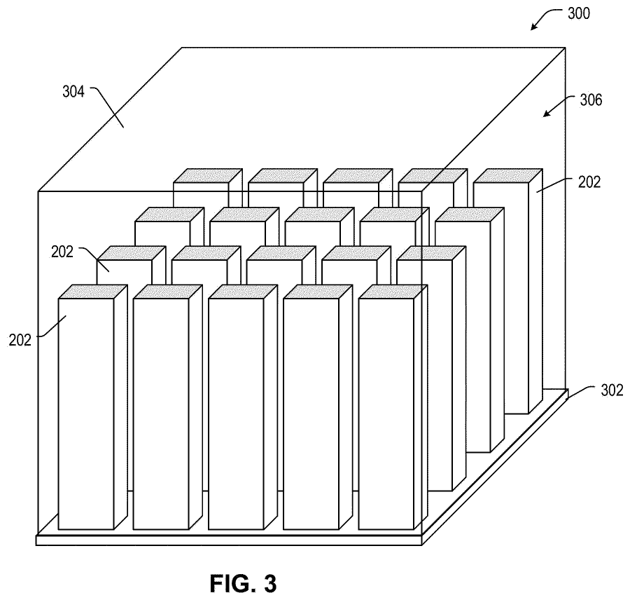

Referring to FIG. 3, a perspective view of an example of a battery pack 300 is shown. Battery pack 300 includes a base 302, a cover 304 and a plurality of batteries 202 coupled together such that the power generated by each cell 202 may be connected to a single device.

Base 302 may be coupled to cover 304 to define a cavity 306 in which the plurality of batteries 202 are disposed. Base 302 and cover 304 operate to separate batteries 202 from the outside environment. In this way, batteries 202 may be shielded from outside contaminants and allow for safe handling of battery pack 300. In some implementations, base 302 and/or cover 304 may include a thermally conductive material (with or without active coolant flow) to further transfer heat away from each cell 202. In the depicted implementation, base 302 and cover 304 are rectangular; however, the base and cover may be shaped or sized in any other suitable arrangement.

As shown in FIG. 3, cover 304 is transparent to show the arrangement of battery pack 300, which may be arranged as a rectangular stack (e.g., square) to comply with space limitations and/or power requirements of a desired application. In this way, the plurality of batteries 202 may be arranged in rows and columns so that that the batteries are positioned in close proximity to provide a maximum number of batteries within a given volume in battery pack 300. The increased thermal distribution of each cell 202, as described above, may allow each cell to be positioned closer together than in conventional battery packs. In some implementations, battery pack 300 may be stackable with one or more other rectangular battery packs (e.g., 300) to provide a higher power output. For the sake of clarity, one or more other components of battery pack 300 are not shown herein. For example, battery pack 300 may include a circuit board, processor, controller, wiring, conductor, resistor, terminal block, electrode terminals, and/or the like. In other implementations, battery pack 300 may be shaped (e.g. triangular) or sized in any other suitable arrangement. In addition, the pack might have suitable structures to provide protection from crash or additional cooling from dielectric liquids or partitioning walls to remove heat from the cell surfaces.

In an illustrative implementation, cell 202 includes a container 260 having one or more walls 261 that define a cavity 262, a plurality of power units 210 disposed within the cavity and a first conductive member (e.g., 240) coupled to the plurality of power units. Each power unit includes a first electrode (e.g., 212, 220), a second electrode (e.g., 214, 230), and a separator 216 disposed between the first and second electrode. The first conductive member may be coupled to the first electrodes (e.g., 212, 220) and disposed within cavity 262 between the first electrodes and at least one of the one or more walls (e.g., 261, 264). In another illustrative implementation, cell 202 includes a container 260 having a first side 264 and a second side 266 and a plurality of power units 210 coupled together and disposed within the container. In some implementations, first side 264 of container 260 opposes second side 266 of the container, and the first and second sides define at least a portion of cavity 262. Each power unit includes a first current collector (e.g., 220), a second current collector (e.g., 230), and a separator 216 disposed between the first current collector and the second current collector. Cell 202 may include a first busbar 240 coupled to the plurality of power units 210 such that the first busbar is in contact with first current collectors (e.g., 220) of the plurality of power units and a second busbar 250 coupled to the plurality of power units such that the second busbar is in contact with second current collectors (e.g., 230) of the plurality of power units. The plurality of power units 210, first busbar 240, and second busbar 250 are disposed within cavity 262. For example, first busbar 240 is interposed between each second portion 224 of first current collectors (e.g., 220) and first side 264 of container 260.

In some implementations, first busbar 240 is in contact with each first electrode (e.g., 220) of the plurality of power units 210. At least one of the first electrodes (e.g., 212, 220) includes a first connector 220 and an active material 212. In such implementations, first current collector (e.g., 220) includes a first portion 222 and a second portion 224 that extends away from the first portion. For example, second portion 224 of first current collector (e.g., 220) extends in a direction that is substantially parallel to a width (e.g., D4) of first busbar 240 The active material 212 may be coupled to first portion 222 of first current collector (e.g., 220). Additionally, or alternatively, first busbar 240 is positioned between a first wall 264 of the one or more walls (e.g., 261) and the second portion 224 of first current collector (e.g., 220). In some implementations, first busbar 240 is in contact with second portion 224 of first current collector (e.g., 220).

Cell 202 may include a second conductive member (e.g., second busbar 250) coupled to second electrodes (e.g., 214, 230). In some such implementations, the one or more walls 261 includes a first wall 264 and a second wall 266 that opposes the first wall, each of the first and second walls defining a portion of cavity 262. Second conductive member 250 may be interposed between the second electrodes (e.g., 214, 230) and second wall 266. Second electrodes (e.g., 214, 230) may include a second current collector (e.g., 230) having a first portion 232 and a second portion (e.g., 234) extending away from the first portion, and an active material 214 coupled to first portion 232 of the second current collector. First portion 222 of first current collector (e.g., 220) may be substantially parallel to first portion 232 of second current collector (e.g., 230). Additionally, or alternatively, second portion 224 of first current collector (e.g., 220) is substantially parallel to second portion (e.g., 234) of second current collector (e.g., 230). In some implementations, first conductive member (e.g., 240) spans an area that is greater than or equal to 25% of first wall 264. Additionally, or alternatively, second conductive member (e.g., 250) spans an area that is greater than or equal to 25% of the second wall 266.

In some such implementations, first current collectors (e.g., 220) include a first portion 222 and a second portion 224 extending from the first portion, the second portion in, contact with first busbar 240. Cell 202 may be arranged such that each power unit 210 of the plurality of power units is stacked together so first portions 222 of each power unit are substantially parallel to one another. In a cross-section of container 260, taken perpendicularly to a length (e.g., D3) of the container, second portion 224 extends in a direction that is substantially perpendicular to first portion 222. Second current collector (e.g., 230) includes a third portion (e.g., 232) and a fourth portion (e.g., 234) extending from the third portion, the fourth portion in contact with second busbar 250. In some implementations, second busbar 250 is interposed between the each fourth portion 234 of second current collectors (e.g., 230) and second side 266 of container 260. First current collectors (e.g., 220) and first busbar 240 may each include a first material and second current collectors (e.g., 230) and second busbar 250 may each include a second material.

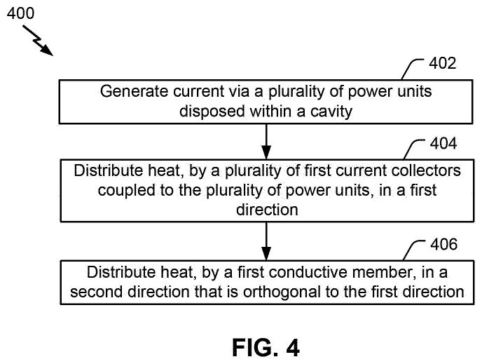

Referring to FIG. 4, an example of a method of operating a cell is shown. Method 400 may be performed by cell 102, 202, and/or battery pack 300 including batteries 102, 202, as non-limiting examples.

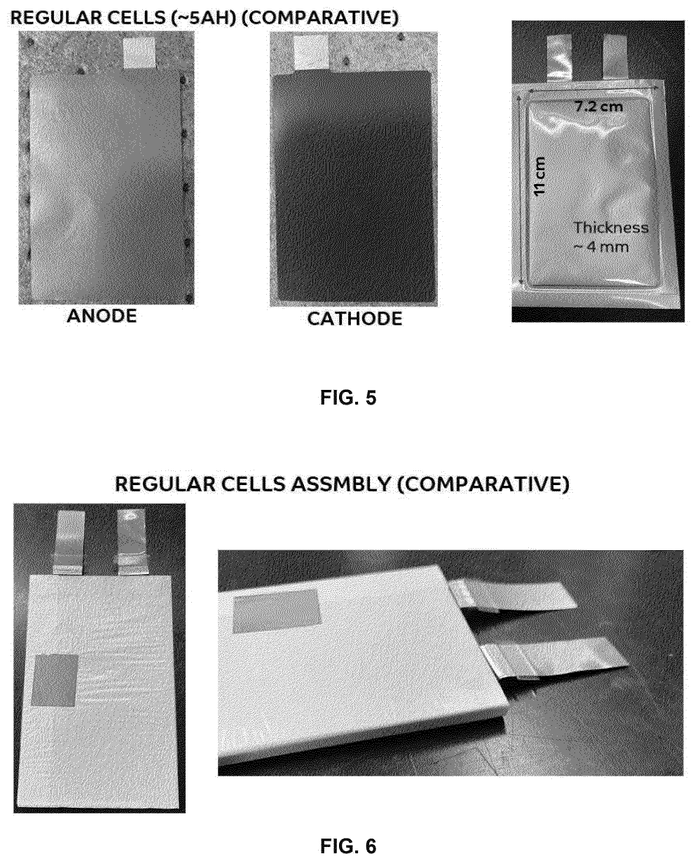

The fabrication of the comparative cell is shown in FIG. 5 and FIG. 6. The specifications of the cell is given below:

| Cell Component | Thickness | |
|---|---|---|
| Cu collector | 12 | μm |
| Al collector | 15 | μm |
| Anode (2-sided) | 113 | μm |
| Cathode (2-sided) | 120 | μm |
| Separator | 14 | μm |
| Pouch | ~165 | μm |

FIG. 5 shows double coated anode over copper collector and double coated cathode over aluminum collector. The dimensions of these electrodes are 7.2 cm×11 cm. The fully assembled cell shown has around 30 cell sandwich layers (copper current collector+cathode+separator+anode+aluminum current collector) making it around 0.4 cms thick having an effective capacity close to 5 Ah. FIG. 6 shows the stacked electrodes with z-folded separator with one final wrapping of the separator.

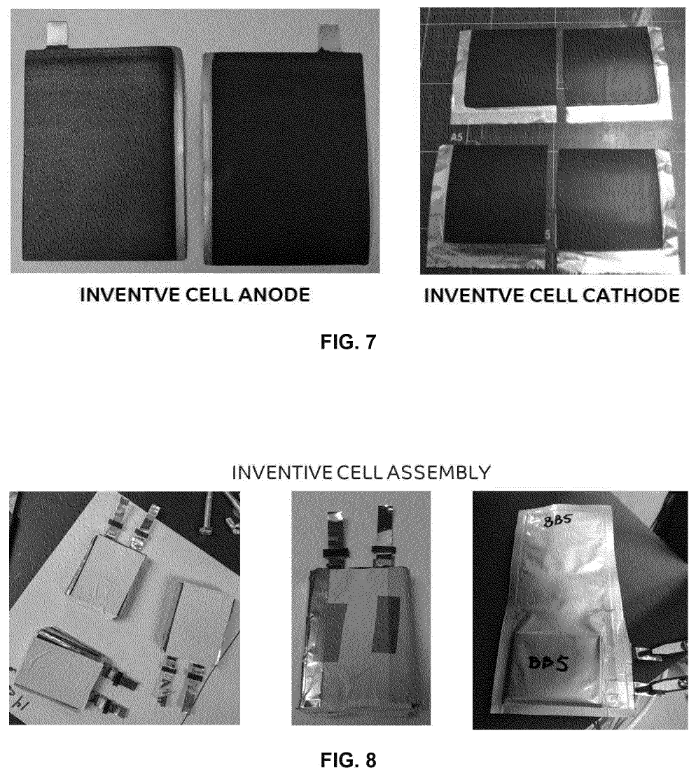

FIG. 7 shows double coated anode over copper collector and double coated cathode over aluminum collector with side tabs exposed without coating. The dimensions of the coated electrodes are 4 cm×6.5 cm. The fully assembled cell shown has around 120 cell sandwich layers (copper current collector+cathode+separator+anode+aluminum current collector) making it around 1.2 cms thick having an effective capacity close to 5 Ah. FIG. 8a shows the inventive cell with electrodes stacked with z-folded separator with side tabs of aluminum and copper exposed. FIG. 8b shows the assembled cell with folded side tabs and in contact with copper and aluminum busbars on either sides. FIG. 8c shows the assembled cell fully enclosed in the pouch going through the formation cycle.

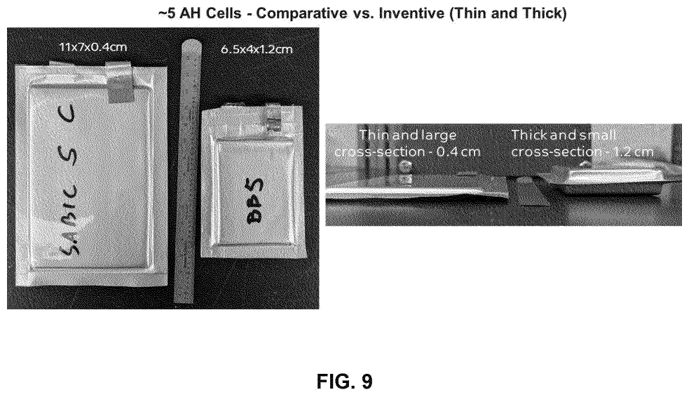

FIG. 9 shows the comparative and inventive cell of capacity close to 5 Ah. The comparative cell has larger surface area with dimensions of 7.2×11 cm and thin with a thickness of 0.4 cm. The inventive cell has significantly smaller surface area with dimensions of 4 cm×6.5 cm but thicker at 1.2 cm.

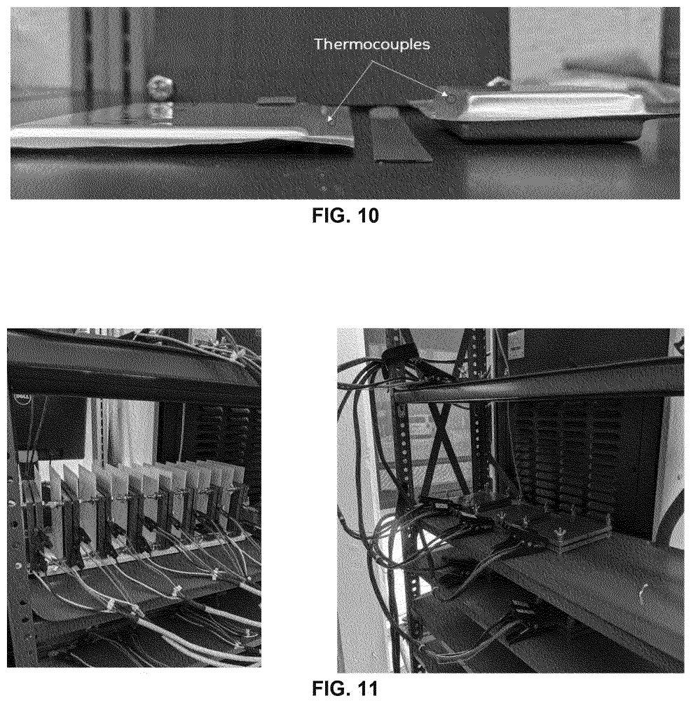

FIG. 10 shows the locations of the thermocouples on both the comparative cell as well as the inventive cell. In the case of the regular cell, the measurement reflects the temperature of the surface layers as there is low conductivity through the thickness of the cell. In the inventive cell, the temperature is reflective of the internal thermal busbars which are thermally connected to the inside of the cell via the current collectors and reflective of the more homogeneous temperature in the cell.

FIG. 11 shows the cycler setup. The following cycling protocols were used to cycle the cells:

1C-1C
1. Do1
2. Advance Cycle
3. 1C CC to 4.2V
4. CV@4.2V until I<C/20
5. Rest 30 minutes
6. 1C CC to 3.0 V
5. Rest for 1 hours
7. Loop=1000

1C-2C
1. Do1
2. Advance Cycle
3. 1C CC to 4.2V
4. CV@4.2V until I <C/20
5. Rest 30 minutes
6. 2C CC to 3.0 V
5. Rest for 1.5 hours
7. Loop=1000

1C-5C
1. Do1
2. Advance Cycle
3.1C CC to 4.2V
4. CV@4.2V until I<C/20
5. Rest 30 minutes
6. 2C CC to 3.0 V
5. Rest for 1.5 hours
7. Loop=1000

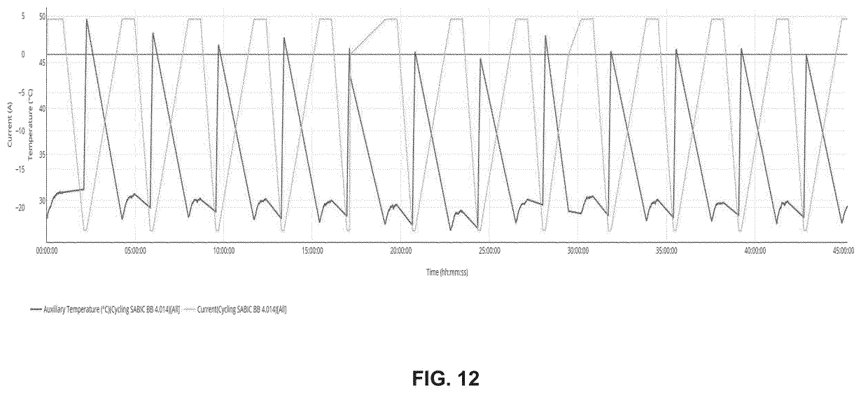

FIG. 12. Shows the temperature vs. current profiles with time for the inventive cell. The cell is charged at 1C and discharged at 5C as described in the protocol above with no active cooling between two fiberglass plates as shown in FIG. 11. The temperatures at the thermocouple can reach between 45 and 50° C. at the end of the discharge as the internal busbar reflects the more homogeneous temperature within the cell as these internal busbars are in contact with highly conductive Al on one side and Cu on the other side. The heat distribution and removal happens through the highly connected network of the internal Cu and Al foils, tabs, and thermal busbars. Al and Cu are electrically isolated by z-folded separator.

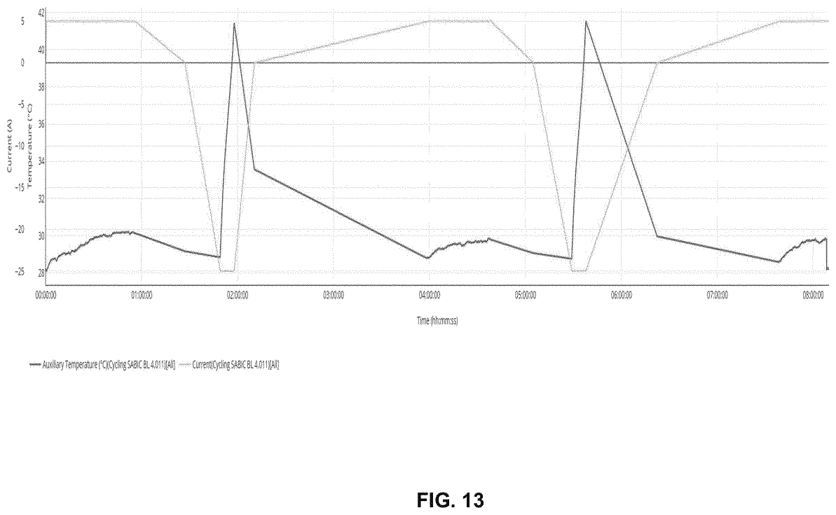

FIG. 13 shows the temperature vs. current profiles with time for the comparative cell. The cell is charged at 1 C and discharged at 5C with no active cooling between two fiberglass plates as shown in FIG. 11. The temperatures can reach to ˜40° C. at the end of the discharge as the surface temperature is not reflective of the highest temperature in the cell that occurs at the core of the cell away from any exposed surface. This is due to the fact that the through thickness conductivity is low as low conductive layers like electrodes, electrolyte, and separator are in series with Cu and Al foils. That is why for the same operating conditions and cell materials, the inventive new format cell has higher temperature in FIG. 12 whereas the regular cell in FIG. 13 will have a internal thermal gradient within the cell and the surface thermocouple is representative of the temperature of the surface layers.

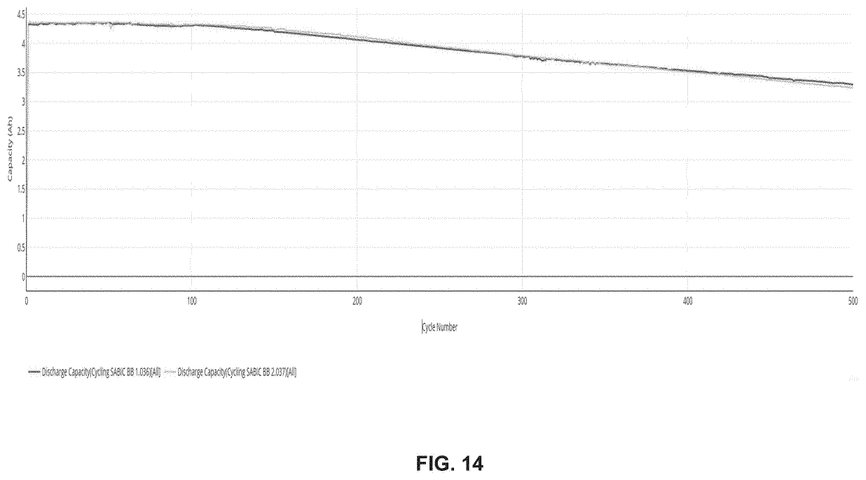

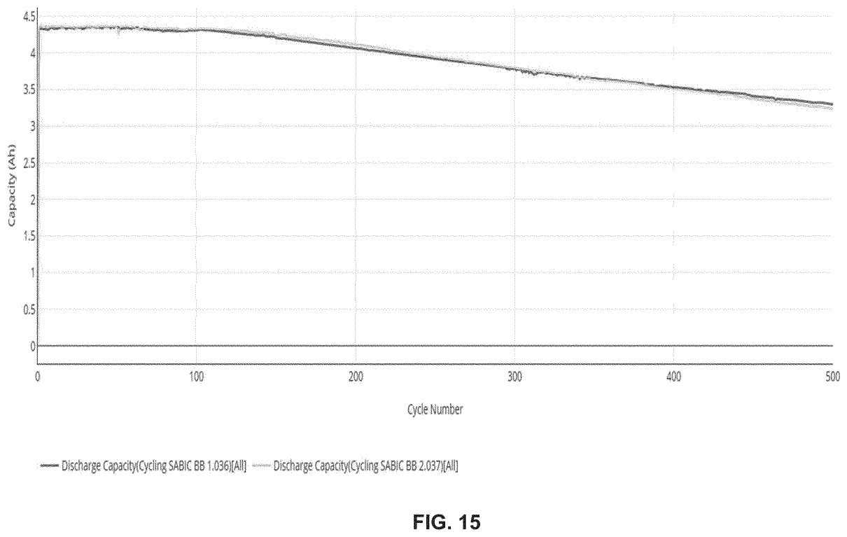

FIG. 14 and FIG. 15 show the capacity of the inventive cell as a function of cycle number with both the 1C-2C and 1C-1C protocols described above. The cell is not cooled (except for parasitic heat losses to air and insulating fiber glass sheets used for clamping the cells) and the cells retain around 75% of the initial capacity even after 500 cycles. Thick cells like the ones shown without the current invention would have degraded much sooner as there would have been an internal thermal gradient with higher core temperatures leading to faster degradation of the capacity. This would cascade as the rest of the cell heats up more during subsequent cycles due to reduced capacity and leading to much shorter cycle times. Modeling indicates that the inventive cell can be kept closer to the desired temperature with effective heat removal from the Al and Cu foil networked with side tabs and internal thermal busbars. Since, Al ands Cu are also good electrical conductors, this will maintain more uniform potential and current flows.

Method 400 includes generating current, by a plurality of power units disposed within a container, at 402. The plurality of power units and the container may include or correspond to power units 110, 210, and container 160, 260, respectively. In some implementations, method 400 may further include charging or discharging the plurality of power units. For example, operating the cell may include transferring power from the plurality of power units to an electrical device.

Method 400 includes distributing heat and current, by a plurality of first current collectors coupled to the plurality of power units, in a first direction, at 404. The plurality of first current collectors may include or correspond to first current collectors 120, 220. In some implementations, distributing heat in the first direction is performed by a body of the first current collectors. For example, the body may transfer heat in a direction that is parallel to a width of the power units. In a particular implementation, the first current collectors distribute heat from a first portion of the body that contacts the power units to a second portion of the body that does not contact the power units.

Method 400 further includes distributing heat, and current, by a first conductive member, in a second direction that is orthogonal to the first direction, at 406. First conductive member may include or correspond to first busbar 140, 240. In some implementations, the first direction corresponds to a direction along a length (e.g., D3, D5) or a thickness (e.g., D2, D4) of the container. In a particular implementation, the first conductive member spans: at least 50% of a thickness or a width of the container and spans at least 80% of a length of the container. In some other implementations (e.g., if cross-section of container is triangular, hexagonal, octagonal), second direction may be angularly disposed relative to the first direction by an angle other than 90 degrees. In some implementations, first and second directions may be angularly disposed at an angle that corresponds to an internal angle of the container.

In some implementations, method 400 may also include distributing heat, by a plurality of second current collectors coupled to the plurality of power units, in a third direction. The plurality of second current collectors may include or correspond to second current collectors 130, 230. In a particular implementation, the third direction is opposite the first direction. Additionally, or alternatively, method 400 may include distributing heat, by a second conductive member, in the second direction that is substantially orthogonal to the first direction. In some implementations, method 400 also includes positioning a plurality of power units, a first conductive member, and a second conductive member within a cavity of the container. The plurality of power units, the first conductive member, and the second conductive member may include or correspond to power units 110, 210, first busbar 140, 240, and second busbar 150, 250, respectively. In a particular implementation, method 400 further includes sealing the cavity of the container. Additionally, or alternatively, method 400 may include charging or discharging the plurality of power units.

Thus, method 400 enables heat in one or more power units to be distributed by a conductive member coupled to the power units. For example, the first current collectors coupled to the first conductive member may conduct heat from one or more power units to the first conductive member and the first conductive member may distribute the heat throughout an entirety of the container. In this way and others, first conductive member and first current collector may regulate the temperature among the power units, increases uniformity, and decrease the hotspots of a cell.

Although aspects of the present application and their advantages have been described in detail, it should be understood that various changes, substitutions and alterations can be made herein without departing from the spirit and scope of the disclosure as defined by the appended claims. Moreover, the scope of the present application is not intended to be limited to the particular implementations of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding implementations described herein may be utilized. Accordingly, the appended claims are intended to include within their scope such processes, machines, manufacture, compositions of matter, means, methods, or steps.

The above specification provides a complete description of the structure and use of illustrative configurations. Although certain configurations have been described above with a certain degree of particularity, or with reference to one or more individual configurations, those skilled in the art could make numerous alterations to the disclosed configurations without departing from the scope of this disclosure. As such, the various illustrative configurations of the methods and systems are not intended to be limited to the particular forms disclosed. Rather, they include all modifications and alternatives falling within the scope of the claims, and configurations other than the one shown may include some or all of the features of the depicted configurations. For example, elements may be omitted or combined as a unitary structure, connections may be substituted, or both. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one configuration or may relate to several configurations. Accordingly, no single implementation described herein should be construed as limiting and implementations of the disclosure may be suitably combined without departing from the teachings of the disclosure.

The previous description of the disclosed implementations is provided to enable a person skilled in the art to make or use the disclosed implementations. Various modifications to these implementations will be readily apparent to those skilled in the art, and the principles defined herein may be applied to other implementations without departing from the scope of the disclosure. Thus, the present disclosure is not intended to be limited to the implementations shown herein but is to be accorded the widest scope possible consistent with the principles and novel features as defined by the following claims. The claims are not intended to include, and should not be interpreted to include, means-plus- or step-plus-function limitations, unless such a limitation is explicitly recited in a given claim using the phrase(s) “means for” or “step for,” respectively.

1. A battery cell comprising:
a container comprising one or more walls that define a cavity;
a plurality of power units disposed within the cavity, each power unit comprising:
a first electrode;
a second electrode; and
a separator disposed between the first and second electrode; and
a first conductive member coupled to at least one of the first electrodes of the plurality of power units, the first conductive member disposed within the cavity between the first electrodes and at least one of the one or more walls and configured to distribute heat and/or current from the at least one first electrode.

2. The cell of claim 1, wherein the first conductive member is in contact with each first electrode of the plurality of power units.

3. The cell of claim 1, wherein:
at least of the first electrodes includes:
a first current collector comprising:
a first portion; and
a second portion extending away from the first portion; and
an active material coupled to the first portion of the first current collector; and
the first conductive member is positioned between a first wall of the one or more walls and the second portion of the first current collector.

4. The cell of claim 1, further comprising:
a second conductive member coupled to the second electrodes; and
wherein:
the one or more walls comprise a first wall and a second wall that opposes the first wall, each of the first and second walls defining a portion of the cavity; and
the second conductive member is interposed between the second electrodes and the second wall.

5. The cell of claim 4, wherein:
the first conductive member includes a first busbar;
the second conductive member includes a second busbar;
the first busbar spans an area that is greater than or equal to 50% of the first wall; and
the second busbar spans an area that is greater than or equal to 50% of the second wall.

6. The cell of claim 4, wherein:
at least one of the first electrodes includes:
a first current collector comprising:
a first portion; and
a second portion extending away from the first portion; and
a first active material coupled to the first portion of the first current collector; and
at least one of the second electrodes includes:
a second current collector comprising:
a first portion; and
a second portion extending away from the first portion; and
a second active material coupled to the first portion of the second current collector.

7. The cell of claim 6, wherein a cross-section of the container is a rectangular, triangular, hexagonal, octagonal, or polygonal.

8. A cell comprising:
a container that includes a first side and a second side;
a plurality of power units coupled together and disposed within the container, each power unit comprising:
a first current collector;
a second current collector; and
a separator disposed between the first current collector and the second current collector;
a first conductive member coupled to the plurality of power units such that the first conductive member is in contact with the first current collectors of the plurality of power units; and
a second conductive member coupled to the plurality of power units such that the second conductive member is in contact with the second current collectors of the plurality of power units.

9. The cell of claim 8, wherein the first current collectors comprise:
a first portion; and
a second portion extending from the first portion, the second portion in contact with the first conductive member.

10. The cell of claim 9, wherein:
the first current collectors and the first conductive member each comprise a first material; and
the second current collectors and the second conductive member each comprise a second material.

11. The cell of claim 9, wherein:
the first side of the container opposes the second side of the container, and the first and second sides define at least a portion of a cavity;
the plurality of power units, the first conductive member, and the second conductive member are disposed within the cavity; and
the first conductive member is interposed between each second portion of the first current collectors and the first side of the container.

12. The cell of claim 9, wherein the second current collectors comprise:
a third portion; and
a fourth portion extending from the third portion, the fourth portion in contact with the second conductive member.

13. A method of operating a battery cell, the method comprising:
charging or discharging a plurality of power units disposed within a container;
transferring heat, by a plurality of first current collectors coupled to the plurality of power units, in a first direction; and
transferring heat, by a first conductive member, in a second direction that is substantially orthogonal to the first direction.

14. The method of claim 13, further comprising:
distributing heat, by a plurality of second current collectors coupled to the plurality of power units, in a third direction; and
distributing heat, by a second conductive member, in the second direction that is substantially orthogonal to the first direction.

15. The method of claim 13, further comprising:
distributing heat, by the first conductive member, in a third direction that is substantially orthogonal to the first direction and the second direction; and
wherein the first conductive member spans:
at least 50% of a thickness or a width of the container; and
at least 80% of a length of the container.
